(19) United States
(12) Patent Application Publication
(10) Pub. No.: US 2010/0299346 A1
(43) Pub. Date: Nov. 25, 2010

(54) DOCUMENT DIAGNOSTIC PROGRAM AND DOCUMENT DIAGNOSIS METHOD

(75) Inventor: Shoji HOKIHIRA, Gifu-shi (JP)

Correspondence Address: ONDA TECHNO INTL. PATENT ATTYS., 12-1, OMIYA-CHO 2-CHOME, GIFU-CITY, 500-8731, JP

(73) Assignee: KABUSHIKI KAISHA ONDA TECHNO, Gifu-shi (JP)

(21) Appl. No.: 12/468,056

(22) Filed: May 19, 2009

(51) Int. Cl. G06F 17/30

(52) U.S. Cl. 707/769; 707/759

(57) ABSTRACT

A document diagnostic program is provided for reducing a check operation checking whether or not a described term is appropriately used with regard to a document whose description content is sectioned by identifiers. The reading means 18 of the computer 11 imports the character data of the specification whose description content is sectioned by a predetermined identifiers from a flexible disk 21 together with the identifiers, and the control means 16 detects a predetermined indication refernee term from the character data of the description content sectioned by the identifiers. Then, the control means 16 searches whether or not the character string which is identical with the character string modified by the indication term exists in the character data of the description content prior to the indication term based on the document diagnostic program.

### TECHNICAL FIELD OF THE INVENTION

This invention relates to a document diagnostic program for a computer to diagnose the propriety of the description content in a document sectioned by an identifier, such as a specification for a patent application, and a document diagnosis method for a computer based on the program.

### BACKGROUND OF THE INVENTION

Specification, which is one of the documents to be filed with the Patent Office when filing a patent application, would have reasons for rejection if its description is not clear. Therefore, before submitting such specification to the Patent Office, a writer reads it over again, checks whether the description is clear enough using appropriate terms, and correct if there is an unclear description.

However, performing such checks requires not only plenty of time but also great attention. Since it is human who performs the check, even though paying great attention and spending plenty of time, he/she may overlook unclear descriptions because of misunderstandings or careless mistakes. Therefore, in order to prevent such overlooking, multiple checks are necessary, and such check operations are a great burden for the writer.

Recently, programs to make a computer automatically check whether inappropriate terms are used in the description of the specification have been produced, and the inventions executing the program to cause the computer to check the description instead of writer have been suggested.

For example, as one of such inventions, there is an invention that causes a computer to check whether demonstrative pronouns are appropriately used in the description content of the document (patent document 1). That is, in the invention, the computer determines whether or not the demonstrative pronouns are used appropriately. It reads the document data of the check document by constant amount (for example, two sentences). Then, it checks whether or not the demonstrative pronouns are appropriately used based on whether or not the target words are described prior to the demonstrative pronouns in the read document data.

### [Patent Document 1]

Japanese Laid-Open Patent Publication No. 5-257970

However, in the specification to be submitted when filing a patent application, its description content is classified by an identifier for the requirement of patent law. In addition, the volume of description content, that is, the amount of character data, in each identifier, is not always the same.

Therefore, as the invention of patent document 1, reading the document data regularly by constant amount (for example, two sentences) and checking the location relationship of the demonstrative pronouns and the target phrases in each read data unit is not suitable for the check method of the specification whose document data volume of the description sectioned by each identifier may vary.

In addition, the description content in each identifier is independent in principle. However, it may have a relation with the other description content shown by other identifier with a specific phrase, i.e. “according to claim 1”. For this reason, even though the data volume of description content in one identifier is as same as the read data volume of the constant amount (for example, two sentences), if a specific phrase, such as “according to claim 1” is included in the description content in the identifier, a sufficient check may not be performed by the check method of the invention of patent document 1. In such case, the writer ultimately has to check whether there are unclear descriptions.

The purpose of this invention is to provide a document diagnostic program and a document diagnosis method to reduce the check operation of the document whose description content is sectioned by an identifier and prevent overlooking in the check.

### DESCRIPTION OF THE INVENTION

To accomplish the above purpose, in a document diagnostic program that causes a computer to emend the document whose description content is sectioned by a predetermined identifier, the invention of claim 1 performs loading the character data into the computer which indicates the description content of the document together with the identifier, detecting a predetermined indication term indicating an already mentioned term in the character data of the description content sectioned by the identifier, and searching whether a character string that is identical with the character string modified by the indication term exists in the character data of the description content prior to the term.

The invention of claim 2 is a document diagnostic program which causes a computer to emend the document submitted to the patent office whose format is preliminary defined by Patent Law, such as a specification whose description content is sectioned by a predetermined identifier, the program comprising the steps of loading a character data indicating the description content of claims in the specification together with a predetermined identifier indicating a claim to the computer, extracting a predetermined determination character string from the character data of the description content sectioned by the identifier, detecting a predetermined indication term from the character data, discriminating between the identifier and other identifier having dependency based on the determination character string, and searching whether the character string that is identical with the character string modified by the indication term in the character data of the description content prior to the indication term, the description content prior to the indication term including the description content sectioned by other identifier discriminated in discriminating step.

In the invention of claim 3, the computer performs to display the searched result of in the searching step on a displaying means.

The invention of claim 4 is a document diagnostic method that a computer emends the document whose description content is sectioned by a predetermined identifier, the computer performs loading the character data indicating the description content of the document together with the identifiers, detecting a predetermined indication term from the character data of the description content sectioned by the identifier, and searching whether or not a character string that is identical with the character string modified by the indication term exists in the character data of the description content prior to the indication term.

The invention of claim 5 is a document diagnostic method which causes a computer to emend the document submitted to the patent office whose format is preliminary defined by Patent Law, such as a specification whose description content is sectioned by a predetermined identifier, the method comprising the steps of the computer loading the character data indicating the description content of claims in the specification together with a predetermined identifier indicating claims, extracting a predetermined determination character string from the character data of the description content sectioned by the identifier, detecting a predetermined indication term from the character data, discriminating between the identifier and other identifier having dependency based on the determination character string, and searching whether or not a character string that is identical with the character string modified by the indication term exists in the character data of the description content prior to the indication term, the description content prior to the indication term including the description content sectioned by other identifiers discriminated in the discriminating step.

In the invention of claim 6, the computer performs to display the searched result in the searching on the display means.

### (Operation)

According to the invention of claims 1 or 4, the computer loads the character data of the document whose description content is sectioned by a predetermined identifier, and determines whether or not the indication term is appropriately used. Therefore, a writer can ensure a check without paying great attention and spending plenty of time.

According to the invention of claims 2 or 5, the computer determines whether or not the indication term is appropriately used after determining the description content indicated by other dependent identifier and depends from the description content indicated by the identifier. Therefore, even though the identifier has a complicated dependency or the description content is classified by many identifiers, the writer can easily determine whether or not the indication term is appropriately used.

According to the invention of claim 3 or 6, the computer displays the searched results on the displaying means. Therefore, a writer can easily determine whether or not indication term is appropriately used.

### BRIEF DESCRIPTION OF THE DRAWINGS

FIG. 1 is a configuration diagram indicating a document preparation apparatus in the present embodiment.

FIG. 2 is a flowchart indicating operating procedure of a document diagnostic program.

FIG. 3 is a flowchart indicating operating procedure of a document diagnostic program.

FIG. 4(a) is a screen figure indicating a document preparation screen.

FIG. 4(b) is a screen figure indicating a check screen.

FIG. 5 is a screen figure indicating a message display unit.

FIG. 6(a) is a screen figure indicating a check screen.

FIG. 6(b) is a screen figure indicating a message display unit.

### DETAILED DESCRIPTION OF THE PREFERRED EMBODIMENTS

Hereinafter, an embodiment that materializes the present invention is described with reference to the drawings 1-5. A computer 11 comprises a body 12, a display 13 as a displaying means connected to the body 12, a keyboard 14 connected to the body 12, and a mouse 15 connected to the body 12. The body 12 comprises a control means 16 including a CPU (Central Processing Unit) and a memory, a storage means 17 storing a document diagnostic program, and reading means 18. The keyboard 14 for inputting the character data and the mouse 15 for performing a selection direction are connected to the control means 16, and to the control means 16, a printer 19 is connected. The mouse 15 is a directing means directing the operating procedure of the document diagnostic program.

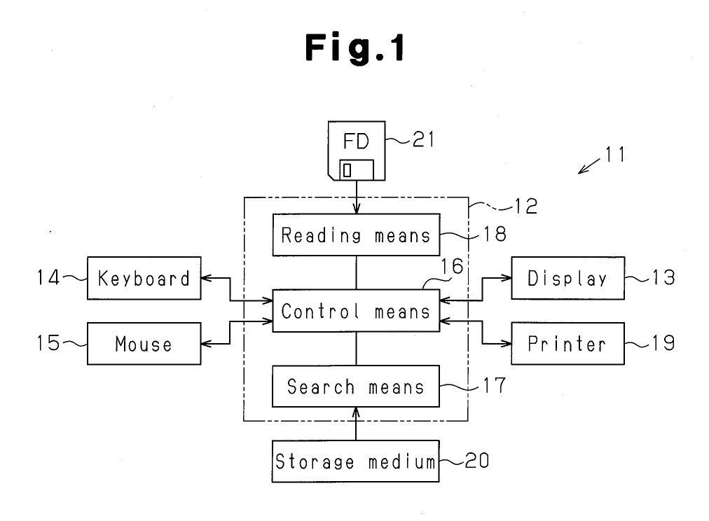

In a storage medium 20 such as CD-ROM shown in FIG. 1, a document diagnostic program is stored. The document diagnostic program stored in the storage means 17 is the program that the document diagnostic program stored in the storage medium 20 is installed. In addition, in the storage means 17, the document preparation program for preparing a document is stored.

A reading means 18 has a function of reading the character data relating to the document stored in a flexible disk 21 to give it to the control means 16 and a function of the character data relating to the document given from the control means 16 in the flexible disk 21.

In the present embodiment, a document refers to a specification attached to a request when filing a patent application. The specification is configured by a predetermined format defined by Patent Law. That is, the description content is classified (sectioned) by an identifier indicated by black lenticular brackets. Here, the term identifier is that the item that is described within the black lenticular brackets and the item within the black lenticular brackets is an index of the description content that the identifier indicates.

There are five types of identifiers, specifically, classified into identifiers indicating the description content relating to “Name of Document”, “Title of the Invention”, “Claims”, “Detailed Description of the Invention”, and “Brief Description of the Drawings”. In the present embodiment, the description content that the identifier “Claims” indicates, that is, the description content of claims is character data from the identifier “Claims” to the identifier “Detailed Description of the Invention”. In the identifier “Claims”, the description content is further classified by the identifiers “Claim N” (N is a whole number 1 or above).

When there are several identifiers “Claim N” in the description content indicated by the identifier “Claims”, the dependent relationship that the description content depends from the description content indicated by other identifier “Claim M” (M is a whole number below N) may be generated depending on the description content indicated by the identifier “Claim N”. The description content that the identifier “Claim N” indicates is the character data described from the identifier “Claim N” to the identifier “Claim L” (L=N+1). Further, the description content indicated by the identifier “Claim N” depending from the description content indicated by the identifier “Claim M” is hereinafter simply called as the identifier “Claim N” depends from the identifier “Claim M”.

The dependency relationship can be determined by a predetermined character string (hereinafter, called a determination character string) existing in the description content indicated by the identifier “Claim N”. This determination character string is determined by the recitations such as “according to claim M”, “in claim M”, or “according to claims O−P” (M<N, O<P<N, O and P are both whole number) in the description content shown by the identifier “claim N”. In the present embodiment, the list of this determination character string is stored in the storage means 17.

In the description content indicated by the identifier “Claim N”, in order to simplify explanation and clarify the meaning of the character string, a predetermined indication term may be used to modify the character string. The indication terms in this embodiment are, for instance, “the”, “said”, “above mentioned” and “this”, and the list of them is stored in the storage means 17. The character strings that the indication term in the embodiment modifies are character strings following from the indication term and before particle.

Therefore, since the character string modified by the indication term is used to simply indicate that it is as same as the character string previously explained, the character string which is identical with the character string modified by the indication term should exist in the description content prior to the indication term. The description content indicated by each identifier is regarded as a character data sectioned (classified) by the identifier. Therefore, a character string that is identical with the modified character string should exist in the range of the indication term backing to an identifier (for instance, “Claim N”).

However, when the identifier “Claim N” depends from the identifier “Claim M”, despite the description content indicated by the identifier “Claim N” including the character string modified by a predetermined indication term, sometimes the modified character string is not found in the description content indicated by the identifier “Claim N”. This is understood that, if the description content indicated by the dependent identifier “Claim M” includes the character string, the indication term is appropriately used, even though the modified character string is not found in the description content indicated by the depended identifier “Claim N”. That is, since the description content of the dependent identifier “Claim M” is already explained in the description content of depended identifier “Claim N”, if the indication term which modifies the character string used in the dependent description content in the depended description content is used, it would be an appropriate usage.

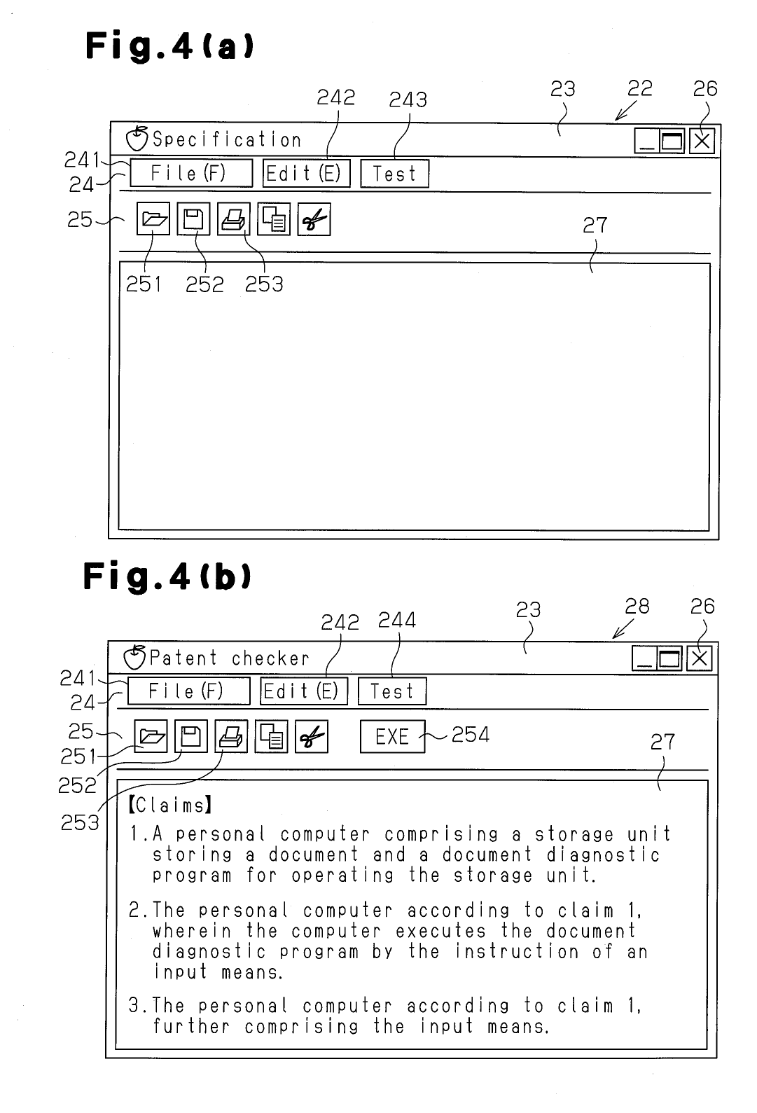

Next is the brief description of the procedure until operating the document diagnostic program. The control means 16 reads the document preparation program stored in the storage means 17 based on the pushing down operation of the keyboard 14 or the selection operation of the mouse 15, and display the document preparation display 22 as shown in FIG. 4(a) based on the document preparation program.

The document preparation display 22 displays a well known title bar 23, a menu bar 24, and a tool bar 25. In the right side of the title bar 23, a termination instruction button 26 is displayed. In the bottom of the tool bar 25, a document display unit 27 for displaying the specification is sectioned and displayed. In the menu bar 24, menu items 241, 242, and 243 are displayed. The menu item 241 is for an operation of files, the menu item 242 is for an operation of document editing, and the menu item 243 is for an operation of document diagnosis. In the tool bar 25, a button 251 for opening files, a button 252 for saving files, and a button 253 for printing are displayed.

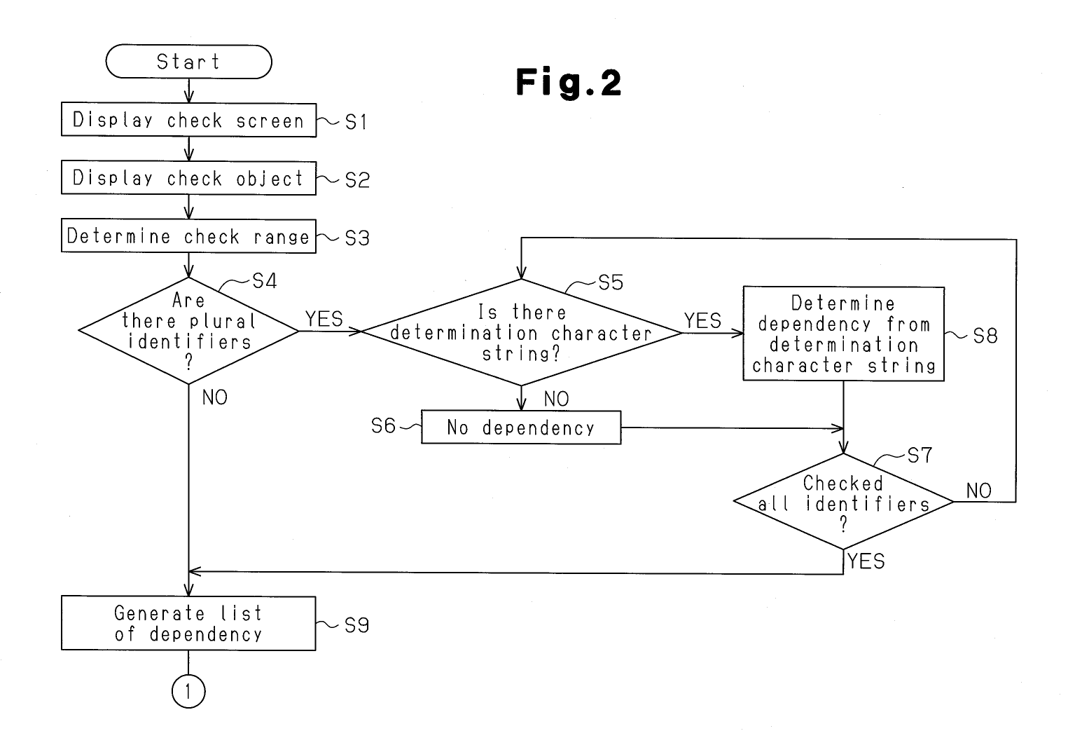

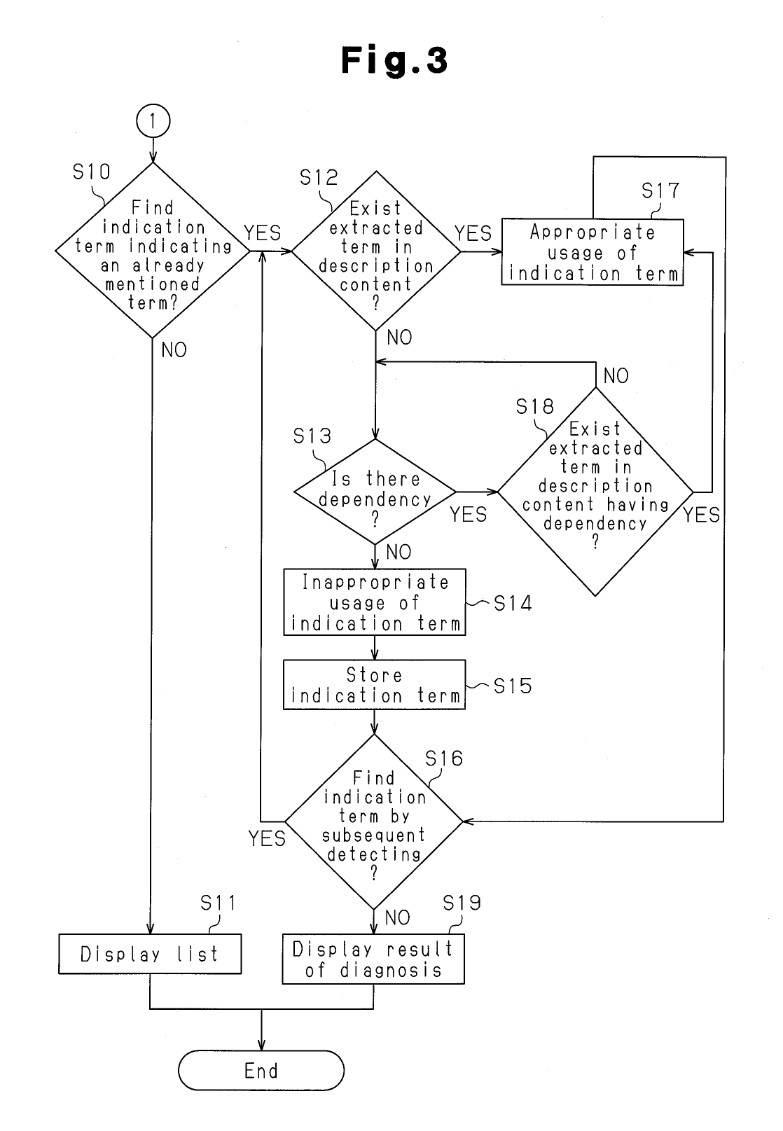

When the menu item 243 is selected by the mouse 15 for operating the document diagnosis, the control means 16 reads the document diagnostic program stored in the storage means 17 and controls the operation based on the document diagnostic program, an input signal from the keyboard 14, and an input signal from the mouse 15. In other words, the control means 16 carries out the operation following the document diagnostic program shown in the flowcharts of FIG. 2 and FIG. 3.

Following is the operation in accordance with the document diagnostic program shown in the flowcharts of FIGS. 2 and 3. As shown in FIG. 4(a), a display 13 shall display the document preparation display 22. In the situation that the document preparation display 22 is being displayed, the control means 16 is waiting until the instruction from the mouse 15 or the keyboard 14 is input. If the menu item 243 is selected by the operation of the mouse 15, the control means 16 displays a check display 28 shown in FIG. 4(b) on the display 13 based on the document diagnostic program (Step S1).

In the check display 28, the well known title bar 23, the menu bar 24, and the tool bar 25 are displayed. In the right side of the tile bar 23, the termination instruction button 26 is displayed. In the bottom of the tool bar 25, a document display unit 27 for displaying the specification is sectioned and displayed. In the menu bar 24, menu items 241, 242, and 244 are displayed. The menu item 244 is for an operation of document diagnosis. In the tool bar 25, a button 251 for opening files, a button 252 for saving files, and a button 253 for printing are displayed. In addition, in the tool bar 25, a button 254 for receiving a starting instruction of the check operation is displayed.

After displaying the check screen 28, a window screen for selecting (displaying a list of titles of the inventions indicating specifications, figures are omitted) is displayed by the button 251 being selected by the operation of the mouse 15. If a title indicating the specification that is a check target is selected on the window screen for selecting by the operation of the mouse 15, the control means 16 reads the character data relating to the specification as the check target, and displays it on the document display unit 27 of the check screen 28 (Step S2). FIG. 4(b) shows a part of claims in the specification as the check target in the document display unit 27 of the check screen 28.

If the button 254 is selected by the mouse 15 in a situation that the check target is displayed on the check screen 28, the control means 16 determines the range of the description content indicated by the identifier “Claims” based on the document diagnostic program, that is, the check range to be checked by the document diagnostic program (Step S3). The control means 16 determines that the range from the identifier “Claims” to the identifier of same rank is the check range. Specifically, the control means 16 determines that the range after the identifier “Claims” to the identifier “Detailed Description of the Invention” is the check range of the description content indicated by the identifier “Claims”.

Next, the control means 16 checks the dependency relationship between the identifiers “Claim N” existing in the description content indicated by the identifier “Claim” based on the document diagnostic program. Specifically, the control means 16 first checks the number of identifiers “Claim N” (Step S4).

In step S4, if the control means 16 determines that there is only the identifier “Claim 1” in the description content indicated by the identifier “Claims”, it determines that the identifier “Claim 1” does not depend from other identifier, terminates checking the dependency relationship, and moves on to the next step S9 (discussed below).

In step S4, if the control means 16 determines that there are a plurality of identifiers “Claim N”, it checks the dependency relationship for all identifiers indicated by the identifier “Claims” in order from the identifier “Claim 1” (Step S5-Step S7).

First, the control means 16 specifies the description content indicated by the identifier “Claim N” and searches whether there is the determination character string in its description content (Step S5). In step S5, if determined that there is no determination character string, the control means 16 determines that the description content indicated by the identifier “Claim N” is an independent claim, that is, does not have dependency relationship with the description content indicated by other identifier “Claim M” (Step S6).

In the present embodiment, as shown in FIG. 4(b), since the character string which is identical with the determination character string in the description content indicated by the identifier “Claim 1” does not exist, the control means 16 determines that the identifier “Claim 1” does not have any dependency relationships.

After step S6, the control means 16 determines whether dependency check is carried out for all identifiers “Claim N” (Step S7). If determined that the check is not completed, the control means 16 again moves on to step S5, and checks similarly whether there is a determination character string in the description content indicated by the next identifier. When it determines that all checks have been completed, the control means 16 moves on to the operation of next step S9 (discussed below).

In step S5, if determined that there exists a determination character string, based on the document diagnostic program, the control means 16 determines (discriminates) which description content indicated by the identifier “Claim M” the description content indicated by the identifier “Claim N” depends from based on the determination character string (Step S8).

Specifically, the determination character string always includes one or more numerals such as “in accordance with claim M”, “in accordance with claims O−P”, and “in claims O, M, P”. Therefore, the control means 16 checks the number of numerals included in the determination character string. When counting the number of numerals, the consecutive numbers are counted as one. For instance, the number string, 123, is counted as one. Further, if Hiragana and Chinese characters are included between numerals, for instance, “2 or 14”, the number of numerals is counted as two.

If the control means 16 determines that only one numeral is included in the determination character string, the description content indicated by the identifier “Claim N” has the dependency relationship with the description content of claim indicated by the numeral. For instance, if only the number “M” is included in the determination character string, the description content indicated by the identifier “Claim N” has the dependency relationship depending from the description content indicated by the identifier “Claim M”.

For instance, in the present embodiment, as shown in FIG. 4(b), the control means 16 determines based on the document diagnostic program that the determination character string “in accordance with claim 1” exists in the description content indicated by the identifier “Claim 2”, and checks the number of numerals included in the determination character string “in accordance with claim 1”. The control means 16 will determine that one numeral is included in the determination character string, and the identifier “Claim 2” has a dependency relationship depending from the identifier “Claim 1”.

If the control means 16 determines that only two numerals are included in the determination character string, based on the document diagnostic program, it checks the character string between numerals, and checks to which description content indicated by the identifier the description content of claim has dependency relationship from the character string.

Specifically, if the character string, such as “-”, and “to”, exists between the numeral “9” and numeral “11”, the control means 16 determines that the description content indicated by the identifier “Claim N” has a dependent relationship with the description content indicated by the identifier “Claim 9”, the identifier “Claim 10”, or the identifier “Claim 11”. Further, for instance, if the character string, such as “or”, exists between numeral “9” and numeral “11”, the control means 16 determines that the description content indicated by the identifier “Claim N” has a dependency relationship depending from the description content indicated by the identifier “Claim 9” or the identifier “Claim 11”.

Also, if determined that more than three numerals are included, the control means 16 similarly determines which description content depends from the description content of the identifier “Claim N” as the case only two numerals are included.

After that, the control means determines whether the dependency check is completed for all identifiers (Step S7). If the check is not completed, it moves back to step S5, and checks whether there is a determination characteristic string in the description content indicated by the next identifier. If the control means 16 determines that all dependency check are completed for all identifiers (YES in step 8), based on the document diagnostic program, it generates a list indicating dependent identifiers whose dependency relationship have been checked, and temporarily stores it (Step S9). In step S4, if determined that there is only one identifier (that is, NO in step S4), it similarly generates a list indicating the identifier is an independent claim, and temporarily stores it (step S9).

After finishing the dependency check, the control means 16 detects whether there is a character string which is identical with the predetermined indication term in the order from the beginning of the description content indicated by the identifier “Claims” based on the document diagnostic program (Step S10).

If determined that a predetermined indication term does not exist in the description content indicated by the identifier “Claims” in step S10, the control means 16 displays a list indicating the dependency relationship on the display screen (step S11), and ends the check operation.

If a predetermined indication term is detected in step S10, the control means 16 extracts the character string that the predetermined indication term modifies and searches whether there is the character string extracted within the range from the indication term to the identifier based on the document diagnostic program (step S12). In FIG. 3, for the convenience of drawings, the extracted character string is abbreviated as “extracted term”.

In step 12, if the extracted character string does not exist within the range, the control means then refers to the list indicating the dependency relationship and determines whether the description content that is a search target has the dependency relationship depending from other description content (step S13).

In step 13, if determined that there is no dependency relationship, the control means 16 determines that the indication term is not used appropriately (step S14). The control means 16 then temporarily stores the indication term which is used inappropriately and the combination of character strings right after it based on the document diagnostic program (step S15).

The control means 16 searches again the predetermined indication term from after the indication term determined whether used appropriately in series of operations to the end of the description content indicated by the identifier “Claims” (step S16). If the indication term is searched again (YES, in step S16), the control means 16 moves on to the operation of step S12. If the indication term is not searched until the end of the description content indicated by the identifier “Claims” (NO, in step S16), the control means 16 moves on to the operation of step S19 (discussed bellow).

In step S12, if the character string that is identical with the extracted character string within the range from the indication term back to the identifier is searched (YES, in step S12), the control means 16 determines that the indication term is appropriately used (step S17), and moves on to the operation of step S16.

If determined there is a dependency relationship in step S13 (YES, in step S13), the control means 16 determines whether the character string that is identical with the character string modified by the indication term in the description content indicated by the dependent identifier (step S18). If determined that the character string identical with the dependent description content exists (YES, in step S18), the control means 18 determines that the indication term is appropriately used (step S17).

In step S18, if determined that the character string does not exist in the dependent description content (NO, in step S18), the control means 16 moves on to the operation of step S13, and determines whether the description content indicated by the dependent identifier further depends from the description content indicated by other identifier. If there is no dependency, the control means 16 moves on to the operation of step S14 similarly as previously described, and determines that the indication term is not used appropriately. If there is dependency, the control means 16 moves on to the operation of step S18, and searches whether there is a character string which is identical with the character string of the description content indicated by the dependent identifier.

Here, a series of processes determining whether the indication term is appropriately used is specifically described in view of drawings. For instance, in the example shown as the document display unit 27 of the check screen 28 in FIG. 4(b), the indication term “the” appears several times in the description content shown by the identifier “Claims”.

To a first “the” described in the description content indicated by the identifier “Claim 1”, the character string “storage unit” is subsequently attached. Therefore, the first “the” refers to the “storage unit” positioned prior to the first “the”. Since there is a character string “storage unit” prior to the first “the”, the control means 16 determines that the first “the” is an appropriately used indication term.

To a second “the” described in the description content indicated by the identifier “Claim 2”, the character string “document diagnostic program” is subsequently attached. Within the range from the second “the” to the identifier “Claim 2”, the character string “document diagnostic program” is not described. However, there is a determination character string “in accordance with claim 1” in the description content indicated by the identifier “Claim 2”. Therefore, the control means 16 refers to the list generated when checking the dependency relationship, determines that the identifier “Claim 2” depends from the identifier “Claim 1”, and checks whether the character string “document diagnostic program” is described in the description content indicated by the identifier “Claim 1”. Since the character string “document diagnostic program” is described in the description content indicated by the identifier “Claim 1”, the second “the” is determined as an appropriately used indication term.

To a third “the” described in the description content indicated by the identifier “Claim 3”, the term “input means” is subsequently attached. Within the range from the third “the” to the identifier “Claim 3”, the character string “input means” is not described. However, there is a determination character string “in accordance with claim 1” in the description content indicated by the identifier “Claim 3”. Then, the control means 16 refers to the list generated when checking dependency relationship, determines that the identifier “Claim 3” depends from the identifier “Claim 1”, and checks whether the character string “input means” is described in the description content indicated by the identifier “Claim 1”. However, the character string “input means” exists in the description content indicated by the identifier “Claim 2” but does not exist in the description content indicated by the identifier “Claim 1”. In addition, since the identifier “Claim 1” does not depend from other identifier, the control means 16 determines that the third “the” is an inappropriately used indication term.

In this way, the control means 16 determines whether the indication term is used appropriately or not. In step S16, when completing the search until the end of the description content indicated by the identifier “Claims” (NO, in step S16), then, the control means 16 displays a message indicating the document diagnostic result on the display screen 30 based on the document diagnostic program.

In this embodiment, the step S2 corresponds to the loading step, and the steps S10 and S16 correspond to the detecting step. In addition, the step S12 and S18 correspond to the searching step, and the step S5 corresponds to the extracting step. Further, the step S8 corresponds to the determining step, and the steps S11 and S19 correspond to the displaying step.

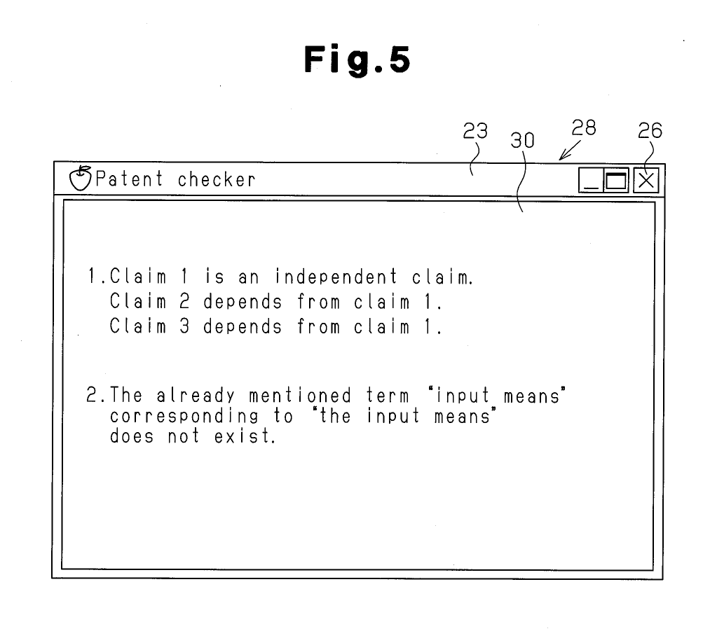

As shown in FIG. 5, the message includes the dependency relationship of the description content indicated by the identifier and the predetermined indication term and the character string right after it those were determined as inappropriate usage and temporarily stored. The writer checks this message and corrects the specification.

As described above, the following effects are obtained in this embodiment.

(1) The control means 16 checks whether the character string subsequently attached to the extracted indication term from the column of claims, that is the description content of the identifier “Claims”, as a check range is used appropriately based on the document diagnostic program. Therefore, the writer can easily figure out whether the indication term in the column of claims is appropriately used referring to the message indicating the check result. Thus, without paying much attention and spending plenty of time, the check whether the indication term in the column of claims is appropriately used can be performed unfailingly. In other words, the document diagnostic program having the column of claims as a check range enables the writer to check whether the indication term in the column of claims is used appropriately without reading the document in the column of claims.

As a result, the check operation checking whether the indication term in the column of claims is appropriately used is reduced, and insufficient check is also eliminated.

(2) The control means 16 checks whether the indication term is appropriately used after checking the dependency relationship between the identifiers. Therefore, even though the identifiers have complicated dependency relationships or the description content is classified by many identifiers, the writer can easily determine whether the indication term is used appropriately.

In this invention, the following embodiments are also possible.
The above embodiment may not display the check target document on the check screen 28 when the check target is selected and instructed. In such case, it displays the document preparation screen 22, displays the check target in the document display unit 27, and corrects the check target document as necessary.
The above embodiment checks whether the indication term is appropriately used with regard to the description content indicated by the identifier “Claim”. However, it may check with regard to the description content indicated by other identifiers.
The above embodiment may have a printer 19 as a displaying unit and print the message by the printer 19.
The above embodiment is applied to the present invention when performing the document diagnosis for the specification attached to the request for filing a patent application. However, this invention may be applied to the specification attached to the request for filing a utility model application when performing document diagnosis.

In the above embodiment, the present invention is applied when performing document diagnosis with regard to the specification attached to the request for filing a patent application. However, it may also be applied when performing document diagnosis with regard to the amendment defined by the Patent Law.

If the description content of the document other than the specification, such as various kinds of technical documents, is classified by a predetermined identifier in above embodiment, the present invention may be applied to such document when performing the document diagnosis.

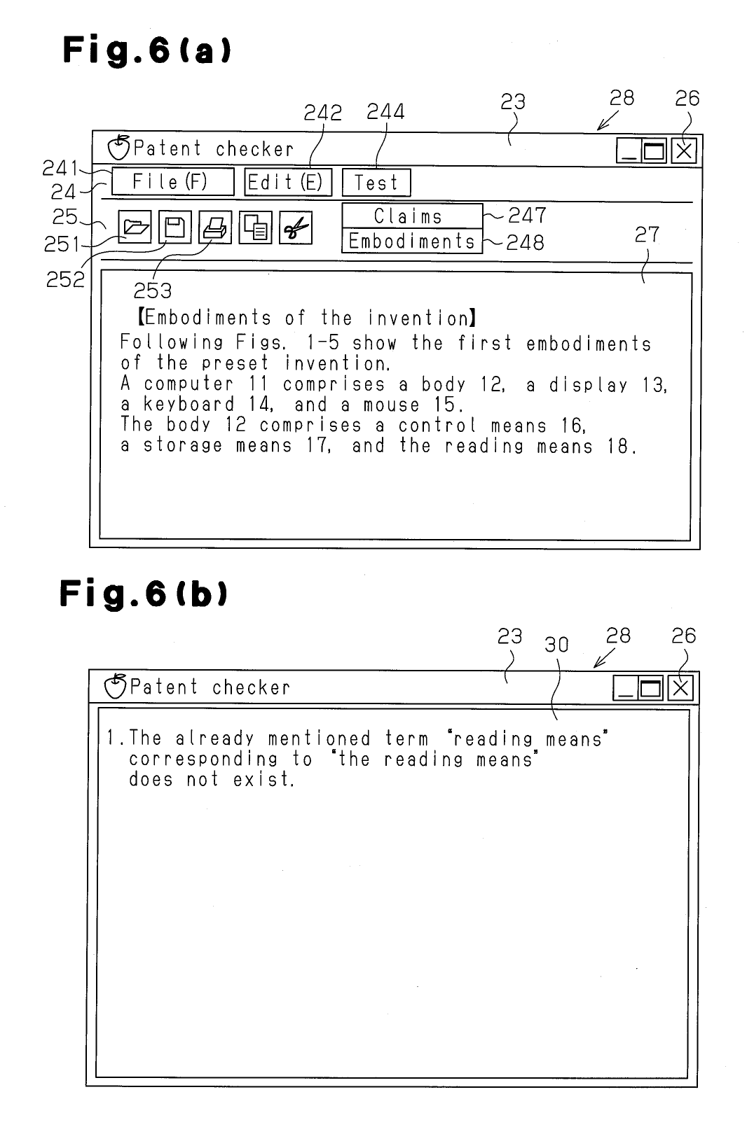

In the above embodiment, the control means 16 sets the description content indicated by the identifier “Claims” as the check range and determines whether the indication term is appropriately used. However, the description content indicated by other identifiers may be the check range. For instance, in FIG. 6(a), the button 247 whose check range is the description content indicated by the identifier “Claims” and the button 248 whose check range is the description content indicated by the identifier “Embodiment of the Invention” is selectively displayed in the tool bar 25. When the button 248 is selected by the mouse 15, the control means 16 sets the description content indicated by the identifier “Embodiment of the Invention” as a check range and determines whether the indication term is used appropriately. The results will be displayed on the display screen 30 as shown in FIG. 6(b).
In the above embodiment, the character string that the indication term modifies is the character string subsequent to the indication term until particles. Instead, alternate term for particle may be set and the character string which includes such term in the ending may be the character string that the indication term modifies. For instance, the character string which includes the term, such as “unit”, “means”, and “program”, in the ending may be the character string that the indication term.

Followings are the inventions understood from the above embodiments.

(a) The document diagnostic program according to claim 3 wherein the result displayed on the display means in the displaying step includes a message indicating the dependency relationship of the identifiers determined in the determining step.

(b) The document diagnostic method according to claim 6 wherein the displaying result on the display means in the displaying step includes a message indicating the dependency relationship of the identifiers determined in the determining step.

With regard to the document whose description content is sectioned by an identifier, the check operation checking whether the described term is appropriately used or not can be reduced. An insufficient check can also be eliminated.

What is claimed is:

1. A document diagnostic program for causing a computer to emend a document whose description content is sectioned by a predetermined identifier, wherein the program causes the computer to execute the steps of:
loading character data indicating the description content of the document together with the identifier;
detecting a predetermined indication term indicating an already mentioned term from the character data in the description content sectioned by the identifier; and
searching whether or not the character string which is identical with the character string modified by the indication term exists in the character data of the description content prior to the indication term.

2. The document diagnostic program according to claim 1, wherein the program causes the computer to display the result searched in the searching step to a display means.

3. A document diagnostic method for causing a computer to emend a document whose description content is sectioned by a predetermined identifier, wherein the computer executes the steps of:
loading character data indicating the description content of the document together with the identifier;
detecting a predetermined indication term indicating an already mentioned term from the character data of the description content sectioned by the identifier; and
searching whether or not a character string which is identical with the character string modified by the indication term exists in the character data of the description content prior to the indication term.

4. The document diagnostic method according to claim 3, wherein the computer executes displaying the result searched in the searching step to the display means.
